(19) United States
(12) Patent Application Publication
(10) Pub. No.: US 2015/0219456 A1
(43) Pub. Date: Aug. 6, 2015

(54) ANGULAR VELOCITY SENSOR

(71) Applicant: SAMSUNG ELECTRO-MECHANICS CO., LTD., Suwon-Si (KR)

(72) Inventors: Jong Woon Kim, Suwon-Si (KR); Tae Yoon Kim, Suwon-Si (KR); Seung Mo Lim, Suwon-Si (KR); Heung Woo Park, Suwon-Si (KR)

(73) Assignee: SAMSUNG ELECTRO-MECHANICS CO., LTD., Suwon-Si (KR)

(21) Appl. No.: 14/334,602

(22) Filed: Jul. 17, 2014

(30) Foreign Application Priority Data
Jul. 31, 2013 (KR) 10-2013-0090990

(51) Int. Cl. G01C 19/5705

(52) U.S. Cl. CPC G01C 19/5705

(57) ABSTRACT

Disclosed herein is an angular velocity sensor, including: a sensing module including a mass body part which includes a plurality of mass bodies disposed to be parallel with each other, an internal frame which movably supports the mass body, and sensing side flexible parts which rotatably connect the mass body to the internal frame; an external frame supporting the sensing module; and a vibration side flexible part rotatably connecting the sensing module to the external frame, wherein the vibration side flexible part is disposed between the internal frame and the external frame to be parallel with each other with respect to a disposition direction of the mass body part which is disposed in the internal frame.

### CROSS REFERENCE TO RELATED APPLICATION

This application claims the benefit of Korean Patent Application No. 10-2013-0090990, filed on Jul. 31, 2013, entitled “Angular Velocity Sensor”, which is hereby incorporated by reference in its entirety into this application.

### BACKGROUND OF THE INVENTION

1. Technical Field

The present invention relates to an angular velocity sensor.

2. Description of the Related Art

Recently, an angular velocity sensor has been used in various applications, for example, military such as an artificial satellite, a missile, and an unmanned aircraft, vehicles such as an air bag, electronic stability control (ESC), and a black box for a vehicle, hand shaking prevention of a camcorder, motion sensing of a mobile phone or a game machine, navigation, and the like.

The angular velocity sensor generally adopts a configuration in which a mass body is adhered to an elastic substrate such as a membrane, in order to measure angular velocity. Through the configuration, the angular velocity sensor may calculate the angular velocity by measuring Coriolis force applied to the mass body.

In detail, a scheme of measuring the angular velocity using the angular velocity sensor is as follows. First, the angular velocity may be measured by Coriolis force “F=2mΩv”, where “F” represents the Coriolis force applied to the mass body, “m” represents a mass of the mass body, “Ω” represents the angular velocity to be measured, and “v” represents a motion velocity of the mass body. Among others, since the motion velocity v of the mass body and the mass m of the mass body are values known in advance, the angular velocity Ω may be obtained by detecting the Coriolis force F applied to the mass body.

Meanwhile, the angular velocity sensor according to the prior art includes a piezoelectric material disposed on a membrane (diaphragm) in order to drive the mass body or sense displacement of the mass body, as disclosed in Patent Document of the following Prior Art Document. In order to measure the angular velocity using the angular velocity sensor, it is preferable to allow a resonance frequency of a driving mode and a resonance frequency of a sensing mode to substantially coincide with each other. However, there may be a very large interference between the driving mode and the sensing mode due to a fine manufacturing error which is caused by shape/stress/physical property, and the like. Therefore, since a noise signal much larger than an angular velocity signal is output, a circuit amplification of the angular velocity signal is limited, such that sensitivity of the angular velocity sensor may be deteriorated.

### PRIOR ART DOCUMENT

### Patent Document

(Patent Document 1) US20110146404 A1

### SUMMARY OF THE INVENTION

The present invention has been made in an effort to provide a detection module for a sensor, which includes a mass body having a first mass body connected to correspond to a center of gravity and a second mass body connected to be spaced apart from the center of gravity and makes a displacement of the mass bodies different, thereby simultaneously detecting physical quantities about multi axes.

Further, the present invention has been made in an effort to provide an angular velocity sensor integrated with a driving unit, which includes a plurality of frames and forms a flexible part allowing a single driving unit to drive the frames and a mass body to individually generate a driving displacement and a sensing displacement of the mass body and allowing the mass body to move only in a specific direction, thereby removing an interference between a driving mode and a sensing mode and reducing an influence due to a manufacturing error.

In addition, the present invention has been made in an effort to provide an angular velocity sensor, which includes a mass body which is mounted in the frame and has a first mass body connected to correspond to a center of gravity and a second mass body connected to be spaced apart from a center of gravity and makes a driving and a displacement of the first mass body and the second mass body different due to frame driving, thereby detecting a tri-axial angular velocity.

Moreover, the present invention has been made in an effort to provide an angular velocity sensor, which includes a vibration side flexible part disposed between an internal frame and an external frame so as to be parallel with a disposition direction of a mass body part disposed in the internal frame, thereby maximally securing a size of a mass body and improving sensing sensitivity.

According to a preferred embodiment of the present invention, there is provided an angular velocity sensor, including: a sensing module including a mass body part which includes a plurality of mass bodies disposed to be parallel with each other, an internal frame which movably supports the mass body, and sensing side flexible parts which rotatably connect the mass body to the internal frame; an external frame supporting the sensing module; and a vibration side flexible part rotatably connecting the sensing module to the external frame, wherein the vibration side flexible part is disposed between the internal frame and the external frame to be parallel with each other with respect to a disposition direction of the mass body part which is disposed in the internal frame.

The mass body part may include: a first mass body connected to the sensing side flexible part so as to correspond to a center of gravity; and a second mass body connected to the internal frame so as to be eccentric by the sensing side flexible part.

The internal frame may be formed to have a “ [symbol] ” shape, may have both sides opened, and may be provided with three space parts in the “ [symbol] ” shape and the space parts may each have the mass bodies received therein.

The internal frame may be provided with a protruding coupling part to which the vibration side flexible part is connected and the protruding coupling part may be formed at both sides of the internal frame.

The protruding coupling part may be formed at both ends of the internal frame, which extends in an X-axis direction, so as to extend in a Y-axis direction.

The external frame may be provided with a protruding coupling part to which the vibration side flexible part connected to the internal frame is connected.

The protruding coupling part of the external frame may protrude toward the internal frame.

The sensing side flexible part may include a first flexible part and a second flexible part which connect each of the first mass body and the second mass body to the frame and the first flexible part and the second flexible part may be disposed in an orthogonal direction to each other.

The first flexible part may be a beam which has a surface formed by one axis direction and the other axis direction and a thickness extending in an orthogonal direction of the surface.

The first flexible part may be a beam which has a predetermined thickness in a Z-axis direction and has a surface formed by an X axis and a Y axis and a width W₁ in an X-axis direction may be formed to be larger than a thickness T₁ in a Z-axis direction.

The second flexible part may have a hinge which has a thickness in one axis direction and has a surface formed in the other axis direction.

The second flexible part may be a hinge which has a predetermined thickness in a Y-axis direction and has a surface formed by an X axis and a Z axis and a width W₂ in a Z-axis direction may be formed to be larger than a thickness T₂ in a Y-axis direction.

One surface of the first flexible part or the second flexible part may be selectively provided with a sensing unit which senses a displacement of the mass body.

The vibration side flexible part may include a third flexible part and a fourth flexible part which connect the internal frame to the external frame and the third flexible part and the fourth flexible part may be disposed in an orthogonal direction to each other.

The third flexible part may be a beam which has a surface formed by one axis direction and the other axis direction and a thickness extending in an orthogonal direction of the surface.

The third flexible part may be a beam which has a predetermined thickness in a Z-axis direction and has a surface formed by an X axis and a Y axis and a width W₃ in a Y-axis direction may be formed to be larger than a thickness T₃ in a Z-axis direction.

The fourth flexible part may be a hinge which has a thickness in one axis direction and has a surface formed in the other axis direction.

The fourth flexible part may be a hinge which has a predetermined thickness in a X-axis direction and has a surface formed by an X axis and a Z axis and a width W₄ in a Z-axis direction may be formed to be larger than a thickness T₄ in an X-axis direction.

One surface of the third flexible part or the fourth flexible part may be selectively provided with a driving unit which drives the internal frame.

When the internal frame is driven by the driving unit of the third flexible part, the internal frame may rotate based on an axis with which the fourth flexible part is coupled, with respect to the external frame.

When the internal frame rotates based on an axis with which the fourth flexible part is coupled, a bending stress may be generated in the third flexible part and a twisting stress may be generated in the fourth flexible part.

When the internal frame rotates based on an axis with which the fourth flexible part is coupled, the first mass body and the second mass body may rotate based on the shaft with which the second flexible part is coupled, with respect to the internal frame.

When the first mass body and the second mass body rotate, the bending stress may be generated in the first flexible part and the twisting stress may be generated in the second flexible part.

Both ends of the first mass body may be connected to the first flexible part with respect to the Y-axis direction and one end of the second mass body may be connected to the first flexible part with respect to the Y-axis direction.

The first mass body may include: a first one side mass body positioned at one side of the second mass body based on the second mass body; and a first other side mass body positioned at the other side of the second mass body based on the second mass body.

One end of the first one side mass body and one end of the first other side mass body may be connected to the second flexible part with respect to an X-axis direction.

The external frame may be provided with a protruding coupling part to which the third flexible part is connected and the protruding coupling part may protrude toward the internal frame.

According to another preferred embodiment of the present invention, there is provided an angular velocity sensor, including: a sensing module including a mass body part which includes a plurality of mass bodies disposed to be parallel with each other, an internal frame which movably supports the mass body, and sensing side flexible parts which rotatably connect the mass body to the internal frame; an external frame supporting the sensing module; and a vibration side flexible part rotatably connecting the sensing module to the external frame, wherein the vibration side flexible part is disposed between the internal frame and the external frame so as to be parallel with the mass body part, and the sensing side flexible part is connected to a first mass body and a second mass body, respectively, so as to correspond to a center of gravity.

The internal frame may have a rectangular pillar shape partitioned into two space parts so as to have the first mass body and the second mass body thereinto.

Both sides of the internal frame may be provided with a protruding coupling part so as to be connected to the vibration side flexible part, the external frame may be provided with the protruding coupling part protruding toward the internal frame so as to be connected to the vibration side flexible part, one end of the vibration side flexible part may be coupled with the protruding coupling part of the internal frame, and the other end thereof may be coupled with the protruding coupling part of the external frame.

The sensing side flexible part may include a first flexible part and a second flexible part which connect each of the first mass body and the second mass body to the frame and the first flexible part and the second flexible part may be disposed in an orthogonal direction to each other.

The vibration side flexible part may include a third flexible part and a fourth flexible part which connect the internal frame to the external frame and the third flexible part and the fourth flexible part may be disposed in an orthogonal direction to each other.

A middle of the internal frame may be provided with a connection part and both sides thereof may be opened to form two space parts, and the space part may have each of the first mass body and the second mass body received therein.

One side of the external frame may be provided with a protruding support part to support the internal frame and the protruding support part may be coupled with the vibration side flexible part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view schematically illustrating an angular velocity sensor according to a first preferred embodiment of the present invention;

FIG. 2 is a plan view of the angular velocity sensor illustrated in FIG. 1;

FIG. 3 is a schematic cross-sectional view taken along the line A-A of the angular velocity sensor illustrated in FIG. 2;

FIG. 4 is a schematic cross-sectional view taken along the line B-B of the angular velocity sensor illustrated in FIG. 2;

FIG. 5 is a schematic cross-sectional view taken along the line C-C of the angular velocity sensor illustrated in FIG. 2;

FIG. 6 is a schematic cross-sectional view taken along the line D-D of the angular velocity sensor illustrated in FIG. 2;

FIG. 7 is a plan view illustrating a movable direction of a first mass body and a second mass body, in the angular velocity sensor illustrated in FIG. 2;

FIG. 8 is a cross-sectional view illustrating the movable direction of the first mass body, in the angular velocity sensor illustrated in FIG. 6;

FIG. 9 is a cross-sectional view illustrating the movable direction of the second mass body, in the angular velocity sensor illustrated in FIG. 5;

FIGS. 10A and 10B are cross-sectional views illustrating a process of allowing the first mass body illustrated in FIG. 6 to rotate based on a second flexible part with respect to an internal frame;

FIGS. 11A and 11B are cross-sectional views illustrating a process of allowing the second mass body illustrated in FIG. 5 to rotate based on the second flexible part with respect to the internal frame;

FIG. 12 is a plan view illustrating a movable direction of the internal frame, in the angular velocity sensor illustrated in FIG. 2;

FIG. 13 is a cross-sectional view illustrating the movable direction of the internal frame, in the angular velocity sensor illustrated in FIG. 3;

FIGS. 14A and 14B are cross-sectional views illustrating a process of allowing the internal frame illustrated in FIG. 3 to rotate based on a fourth flexible part with respect to an external frame;

FIG. 15 is a perspective view schematically illustrating an angular velocity sensor according to a second preferred embodiment of the present invention;

FIG. 16 is a schematic plan view of the angular velocity sensor illustrated in FIG. 15;

FIG. 17 is a schematic cross-sectional view taken along the line A-A of the angular velocity sensor illustrated in FIG. 16;

FIG. 18 is a schematic cross-sectional view taken along the line B-B of the angular velocity sensor illustrated in FIG. 16;

FIG. 19 is a plan view schematically illustrating an angular velocity sensor according to a third preferred embodiment of the present invention; and

FIG. 20 is a plan view schematically illustrating an angular velocity sensor according to a fourth preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

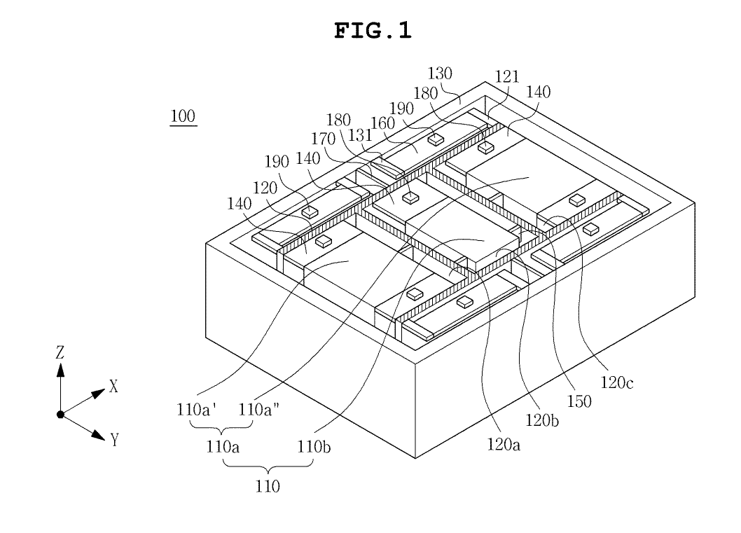

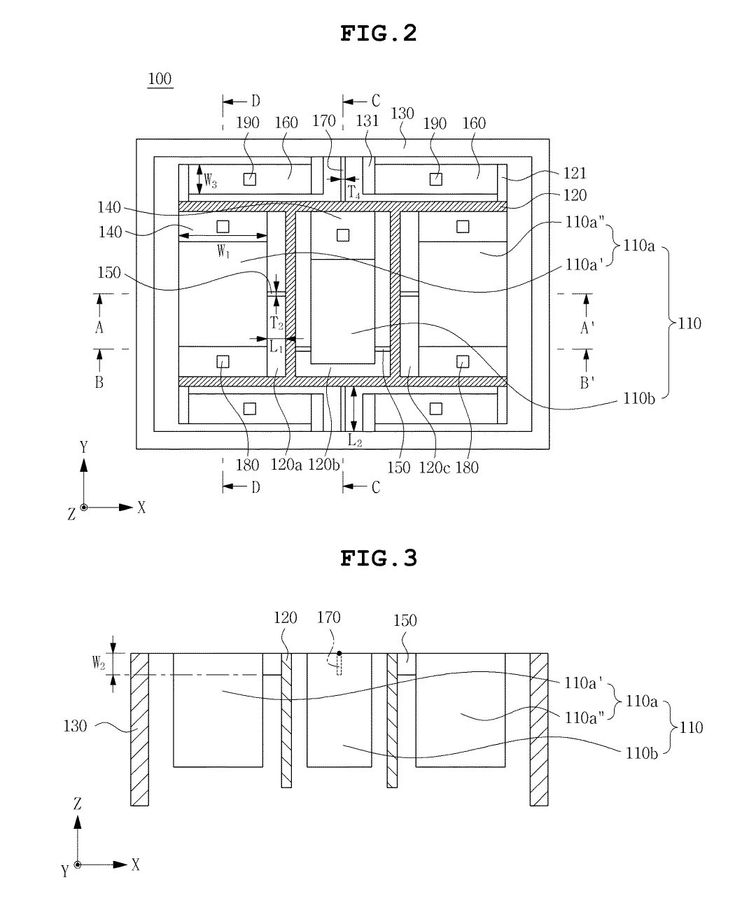

FIG. 1 is a perspective view schematically illustrating an angular velocity sensor according to a first preferred embodiment of the present invention and FIG. 2 is a plan view of the angular velocity sensor illustrated in FIG. 1.

As illustrated, an angular velocity sensor 100 includes a sensing module which includes a mass body part 110 including a plurality of mass bodies disposed to be parallel with each other, an internal frame 120 movably supporting the mass body part 110, and sensing side flexible parts 140 and 150 rotatably connecting the mass body part 110 to the internal frame 120, an external frame 130 supporting the sensing module, and a vibration side flexible parts 160 and 170 rotatably connecting the sensing module to the external frame.

Further, the vibration side flexible part is disposed between the internal frame and the external frame to be parallel with each other with respect to a disposition direction of the mass body part which is disposed in the internal frame.

That is, the angular velocity sensor 100 includes the mass body part 110, the internal frame 120, the external frame 130, the first flexible part 140, the second flexible part 150, the third flexible part 160, and the fourth flexible part 170, in which the first flexible part 140 and the second flexible part 150 are selectively provided with a sensing unit 180 as a sensing side flexible part and the third flexible part 160 and the fourth flexible part 170 is selectively provided with a driving unit 190 as a vibration side flexible part.

In more detail, the mass body part 110 is displaced by Coriolis force and includes a first mass body 110a and a second mass body 110b.

Further, a central portion of the first mass body 110a is connected to the second flexible part 150 to correspond to a center of gravity and the second mass body 110b is connected to the second flexible part 150 to be spaced apart from the center of gravity and thus is connected to the internal frame to be eccentric by the second flexible part.

Further, the first mass body 110a and the second mass body 110b may be formed to have the same size and as illustrated in FIG. 2, as the internal frame 120 is formed to have a “ [symbol] ” shape, the mass body may be largely secured by opening the frame to both sides thereof, such that the first mass body 110a may be formed to be larger than the second mass body 110b.

Further, the first mass body 110a includes a first one side mass body 110a′ which is disposed at one side of the second mass body 110b and a first other side mass body 110a″ which is positioned at the other side of the second mass body 110b. Further, the first one side mass body 110a′ and the first other side mass body 110a″ are formed to have the same size and are disposed at both sides of the second mass body 110b to be symmetrical with each other.

Further, when the first mass body 110a is applied with the Coriolis force, the first mass body 110a is displaced based on the internal frame 120 by a bending of the first flexible part 140 and a twisting of the second flexible part 150. In this case, the first mass body 110a rotates based on an X axis with respect to the internal frame 120 and the detailed contents thereof will be described below.

Meanwhile, the first mass body 110a has a rectangular pillar shape as a whole, but is not limited thereto and therefore the first mass body 110a may be formed to have all shapes known in the art.

Further, only one side of the second mass body 110b is connected to the first flexible part 140 in a Y-axis direction. Further, the other side of the second mass body 110b is connected to the second flexible part 150 in an X-axis direction. That is, the one side of the second mass body is connected to the internal frame 120 by the first flexible part 140 in the Y-axis direction and the other side thereof is connected to the internal frame 120 by the second flexible part 150.

Further, the internal frame 120 supports the mass body part 110. In more detail, the mass body part 110 may be inserted into the internal frame 120 and the mass body part 110 is connected to the internal frame 120 by the first and second flexible parts 140 and 150. That is, the internal frame 120 secures a space in which the mass body part 110 may be displaced, which becomes a basis when the mass body part 110 is displaced. Further, the internal frame 120 may also be formed to cover only a part of the mass body part 110.

Next, the external frame 130 supports the internal frame 120. In more detail, the external frame 130 is provided outside the internal frame 120 to be spaced apart from the internal frame 120 and is connected to the internal frame 120 by the third and fourth flexible parts 160 and 170. Therefore, the internal frame 120 and the mass body part 110 connected thereto are supported by the external frame 130 in a floating state so as to be displaced. Further, the external frame 130 may also be formed to cover only a part of the internal frame 120.

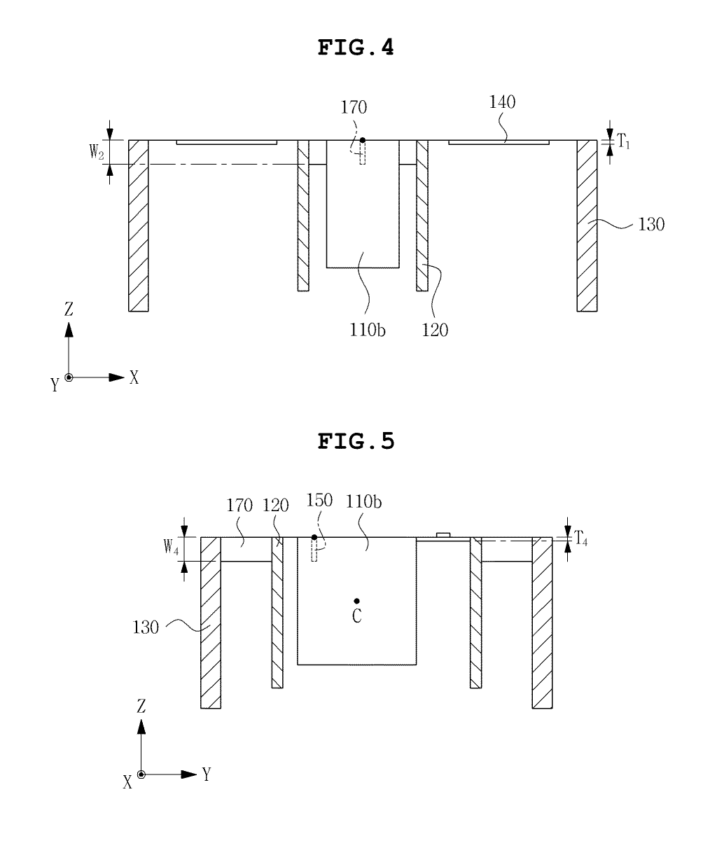

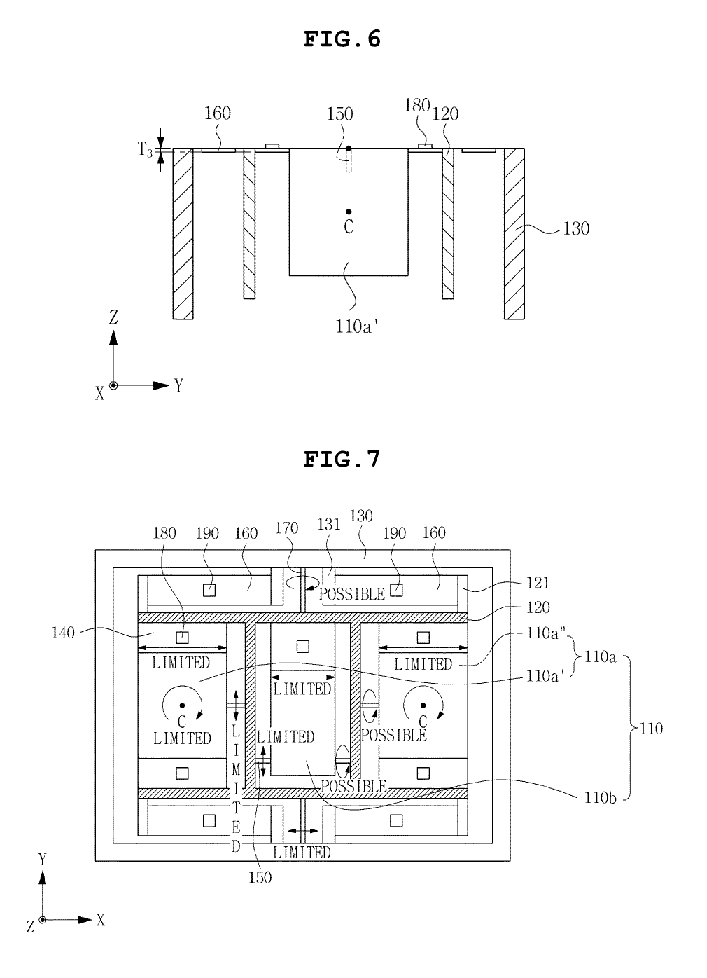

FIG. 3 is a schematic cross-sectional view taken along the line A-A of the angular velocity sensor illustrated in FIG. 2, FIG. 4 is a schematic cross-sectional view taken along the line B-B of the angular velocity sensor illustrated in FIG. 2, FIG. 5 is a schematic cross-sectional view taken along the line C-C of the angular velocity sensor illustrated in FIG. 2, and FIG. 6 is a schematic cross-sectional view taken along the line D-D of the angular velocity sensor illustrated in FIG. 2.

Hereinafter, structural features, shapes, and an organic coupling of each component of the angular velocity sensor 100 according to the first exemplary embodiment of the present invention will be described in more detail with reference to FIGS. 3 to 6 as well as FIGS. 1 and 2.

In more detail, the internal frame 120 may be partitioned into three space parts 120a, 120b, and 120c so that the first mass body 110a and the second mass body 110b may be inserted into the internal frame 120, that is, the first one side mass body 110a′ and the first other side mass body 110a″ may be each disposed at both sides of the second mass body 110b to be symmetrical with each other.

Further, the internal frame 120 secures a space in which the first mass body 110a and the second mass body 110b connected to each other by the first flexible part 140 and the second flexible part 150 may be displaced, which becomes a basis when the first mass body 110a and the second mass body 110b are displaced.

Here, the first frame 120 may have a rectangular pillar shape in which it has a rectangular pillar shaped cavity formed at the center thereof, but is not limited thereto.

As described above, the internal frame 120 of the angular velocity sensor according to the first preferred embodiment of the present invention may be formed to have the “ [symbol] ” shape and as the internal frame 120 is formed to be opened to both sides, the internal frame 120 is to largely secure the mass body as much as a thickness of the frame.

Further, the internal frame 120 is provided with a protruding coupling part 121 so as to be connected to the third flexible part 160. Further, the protruding coupling part 121 may be variously formed to be opposite to a connection direction of the third flexible part 160 and in the angular velocity sensor 100 according to the first preferred embodiment of the present invention, the protruding coupling parts 121 are each formed at both ends of the opened frame to extend toward the external frame, thereby maximally securing a formation space of the mass body. That is, the protruding coupling parts 121 are formed at both ends of the internal frame 120, which extends in an X-axis direction, so as to extend in a Y-axis direction.

Further, one end of the first mass body 110a is connected to the internal frame 120 in the X-axis direction by the second flexible part 150 and both ends of the second mass body 110b are connected to the internal frame 120 in the X-axis direction by the second flexible part 150.

In this case, a central portion of the first mass body 110a is connected to the second flexible part 150 with respect to the Y-axis direction and the second mass body 110b is connected to the second flexible part 150, being spaced apart from the central portion thereof by a predetermined interval with respect to the Y-axis direction. Therefore, the second mass body is connected to the internal frame to be eccentric.

Further, each of the first mass body 110a and the second mass body 110b is connected to the internal frame 120 by the first flexible part 140 in the Y-axis direction. In this case, both ends of the first mass body 110a are connected to the first flexible part 140 and one end of the second mass body 110b is connected to the first flexible part 140.

Further, the first flexible part 140 is a beam which has a predetermined thickness in a Z-axis direction and is formed to have a surface formed by an X axis and a Y axis. That is, the first flexible part is formed so that a width W₁ of the first flexible part in the X-axis direction is larger than a thickness T₁ thereof in the Z-axis direction.

Further, the first flexible part may be provided with the sensing unit 180. That is, when viewed based on an XY plane, the first flexible part 140 is relatively wider than the second flexible part 150, such that the first flexible part 140 may be provided with the sensing unit 180 which senses a displacement of the first mass body 110a and the second mass body 110b.

Further, the sensing unit 180 is not particularly limited, but may be formed to use a piezoelectric type, a piezoresistive type, a capacitive type, an optical type, and the like.

Further, the second flexible part 150 is a hinge which has a predetermined thickness in the Y-axis direction and is formed to have a surface formed by the X axis and a Z axis. That is, the second flexible part 150 may be formed so that a width W₂ of the second flexible part 150 in the Z-axis direction is larger than a thickness T₂ thereof in the Y-axis direction.

Further, the first flexible part 140 and the second flexible part 150 are disposed in an orthogonal direction to each other. That is, the first flexible part 140 is coupled with the mass body part 110 and the internal frame 120 in the Y-axis direction and the second flexible part 150 is coupled with the mass body part 110 and the internal frame 120 in the X-axis direction.

By the above configuration, since the width W₂ of the second flexible part 150 in the Z-axis direction is larger than the thickness T₂ thereof in the Y-axis direction, the mass bodies 110a and 110b are limited from rotating based on the Y axis or being translated in the Z-axis direction, but may relatively freely rotate based on the X axis. That is, the mass bodies 110a and 110b are inserted into the internal frame 120 to rotate based on the X-axis direction and the second flexible part 150 serves as the hinge for this.

Further, the external frame 130 supports the internal frame 120. Further, the external frame 130 is positioned outside the internal frame 120 so as to be spaced apart from each other by a predetermined interval and is connected to the internal frame 120 by the third and fourth flexible parts 160 and 170.

Further, the external frame 130 supports the third and fourth flexible parts 160 and 170 to secure a space in which the internal frame 120 may be displaced, which becomes a basis when the internal frame 120 is displaced. Further, the external frame 130 may have a rectangular pillar shape in which it has a rectangular pillar shaped cavity formed at the center thereof, but is not limited thereto.

Further, the external frame 130 is provided with a protruding coupling part 131 so as to be connected to the third flexible part 160. Further, the protruding coupling part 131 may be variously formed to be opposite to the connection direction of the third flexible part 160 and in the angular velocity sensor 100 according to the first preferred embodiment of the present invention, the protruding coupling parts 131 is formed to be parallel with the protruding coupling part 121 of the internal frame 120 and protrude toward the internal frame.

That is, the protruding coupling part 131 protrudes in the Y-axis direction so as to be parallel with the protruding coupling part 121 of the internal frame 120 protruding in the Y-axis direction and both ends of the third flexible part 160 are each connected to the protruding coupling part 121 of the internal frame 120 and the protruding coupling part 131 of the external frame 130.

Further, the third flexible part 160 is a beam which has a predetermined thickness in the Z-axis direction and is formed to have a surface formed by the X axis and the Y axis. That is, the third flexible part 160 is formed so that a width W₃ of the third flexible part in the Y-axis direction is larger than a thickness T₃ thereof in the Z-axis direction. Further, the third flexible part 160 is disposed to be parallel with the first flexible part 140.

Further, the fourth flexible part 170 is a hinge which has a predetermined thickness in the X-axis direction and is formed to have a surface formed by the Y axis and the Z axis. That is, the fourth flexible part 170 may be formed so that a width W₄ of the fourth flexible part 170 in the Z-axis direction is larger than a thickness T₄ thereof in the X-axis direction.

Further, the third flexible part 160 and the fourth flexible part 170 are disposed to extend in an orthogonal direction to each other. That is, the third flexible part 160 is coupled with the internal frame 120 and the external frame 130 in the X-axis direction and the fourth flexible part 170 is coupled with the internal frame 120 and the external frame 130 in the Y-axis direction.

Further, the third and fourth flexible parts 160 and 170 each connect the external frame 130 to the internal frame 120 so as to displace the internal frame 120 based on the external frame 130.

That is, the third flexible part 160 connects the internal frame 120 and the external frame 130 to each other in the X-axis direction and the fourth flexible part 170 connects the internal frame 120 and the external frame 130 to each other in the Y-axis direction.

Further, the third flexible part 160 and the fourth flexible part 170 are selectively provided with the driving unit 190 and the driving unit 190 is to drive the internal frame 120 and the mass body part 110 and may be formed to use a piezoelectric type, a capacitive type, and the like. In addition, when viewed based on the XY plane, the third flexible part 160 is relatively wider than the fourth flexible part 170. Therefore, the third flexible part 160 may be provided with the driving unit 190 which drives the internal frame 120.

In this case, the driving unit 190 may drive the internal frame 120 so as to rotate based on the Y axis. In this case, the driving unit 190 is not particularly limited, but may be formed to use a piezoelectric type, a capacitive type, and the like.

Further, since the width W₄ of the fourth flexible part 170 in the Z-axis direction is larger than the thickness T₄ thereof in the X-axis direction, the internal frame 120 is limited from rotating based on the X axis or being translated in the Z-axis direction, but may relatively freely rotate based on the Y axis. That is, the internal frame 120 is fixed to the external frame 130 and rotates based on the Y-axis direction. The fourth flexible part 170 serves as the hinge for this.

Further, as described above, as the first flexible part 140, the second flexible part 150, the third flexible part 160, and the fourth flexible part 170 are disposed, the first flexible part 140 and the third flexible part 160 are disposed to be parallel with each other and the second flexible part 150 and the fourth flexible part 170 are disposed in an orthogonal direction to each other.

Further, the second flexible part 150 and the fourth flexible part 170 of the angular velocity sensor according to the preferred embodiment of the present invention may be formed in all the possible shapes, such as a hinge shape of which the cross section is a quadrangle, a torsion bar shape of which the cross shape is a circle.

Further, in the angular velocity sensor according to the first preferred embodiment of the present invention, a technology of forming a driving unit in the fourth flexible part without including the third flexible part may be configured.

Hereinafter, in the angular velocity sensor according to the first preferred embodiment of the present invention, a movable direction of the mass body will be described in more detail with reference to the drawings.

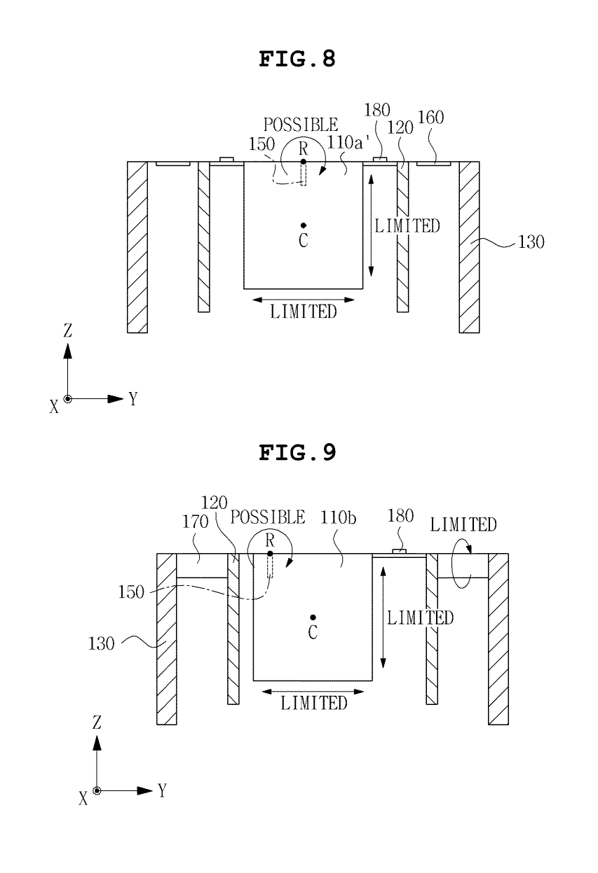

FIG. 7 is a plan view illustrating a movable direction of a first mass body and a second mass body, in the angular velocity sensor illustrated in FIG. 2, FIG. 8 is a cross-sectional view illustrating the movable direction of the first mass body, in the angular velocity sensor illustrated in FIG. 6, and FIG. 9 is a cross-sectional view illustrating the movable direction of the second mass body, in the angular velocity sensor illustrated in FIG. 5.

First, since the width W₂ of the second flexible part 150 in the Z-axis direction is larger than the thickness T₂ thereof in the Y-axis direction, the first and second mass bodies 110a and 110b are limited from rotating based on the Y axis or being translated in the Z-axis direction, but may relatively freely rotate based on the X axis, with respect to the internal frame 120.

More specifically, as rigidity of the second flexible part 150 at the time of rotation based on the X axis is larger than the rigidity thereof at the time of rotation based on the Y axis, the first and second mass bodies 110a and 110b may freely rotate based on the X axis, but are limited from rotating based on the Y axis.

Similarly, as the rigidity of the second flexible part 150 at the time of rotation based on the X axis is larger than the rigidity thereof at the time of the translation in the Z-axis direction, the first and second mass bodies 110a and 110b may freely rotate based on the X axis, but are limited from being translated in the Z-axis direction.

Therefore, as a value of (the rigidity of the second flexible part 150 at the time of the rotation based on the Y axis or the rigidity of the second flexible part 150 at the time of the translation in the Z-axis direction)/(the rigidity of the second flexible part 150 at the time of the rotation based on the X axis) of the second flexible part 150 increases, the first and second mass bodies 110a and 110b may freely rotate based on the X axis, but are limited from rotating based on the Y axis or being translated in the Z-axis direction, with respect to the internal frame 120. Referring to FIGS. 2 and 6, relationships between the width W₂ of the second flexible part 150 in the Z-axis direction, the length L1 thereof in the X-axis direction, and the thickness T₂ thereof in the Y-axis direction and the rigidities thereof in each direction may be arranged as follows.

(1) The rigidity of the second flexible part 150 at the time of the rotation based on the Y axis or the rigidity thereof at the time of the translation in the Z-axis direction∝W₂³×T₂/L₁³

(2) The rigidity of the second flexible part 150 at the time of the rotation based on the X axis∝T₂³W₂/L₁

According to the above two Equations, the value of (the rigidity of the second flexible part 150 at the time of the rotation based on the Y axis or the rigidity of the second flexible part 150 at the time of the translation in the Z-axis direction)/(the rigidity of the second flexible part 150 at the time of the rotation based on the X axis) of the second flexible part 150 is in proportion to (W₂/(T₂L₁))²

However, since the second flexible part 150 according to the present embodiment has the width W₂ in the Z-axis direction larger than the thickness T₂ in the Y-axis direction, (W₂/(T₂L₁))² is large, such that the value of (the rigidity of the second flexible part 150 at the time of the rotation based on the Y axis or the rigidity of the second flexible part 150 at the time of the translation in the Z-axis direction)/(the rigidity of the second flexible part 150 at the time of the rotation based on the X axis) of the second flexible part 150 increases. Due to these characteristics of the second flexible part 150, the first and second mass bodies 110a and 110b are freely rotated based on the X axis, but are limited from rotating based on the Y axis or being translated in the Z-axis direction, with respect to the internal frame 120.

Meanwhile, the first flexible part 140 has relatively very high rigidity in the length direction (Y-axis direction), such that the first mass body 110a and the second mass body 110b may be limited from rotating based on the Z axis or being translated in the Y-axis direction, with respect to the internal frame 120.

Further, the second flexible part 150 has relatively very high rigidity in the length direction (X-axis direction), such that the first mass body 110a and the second mass body 110b may be limited from being translated in the X-axis direction, with respect to the internal frame 120. As a result, due to the characteristics of the first and second flexible parts 140 and 150 described above, the first and second mass bodies 110a and 110b may rotate based on the X axis, but are limited from rotating based on the Y axis or Z axis or being translated in the Z, Y, or X-axis direction, with respect to the internal frame 120. That is, the movable directions of the first and second mass bodies 110a and 110b may be arranged as in the following Table 1.

TABLE 1

| Moving direction of first mass body | |
|---|---|
| and second mass body | Whether or |
| (Based on internal frame) | not movement is possible |
| Rotation based on X axis | Possible |
| Rotation based on Y axis | Limited |
| Rotation based on Z axis | Limited |
| Translation in X-axis direction | Limited |
| Translation in Y-axis direction | Limited |
| Translation in Z-axis direction | Limited |

As described above, since the first and second mass bodies 110a and 110b may rotate based on the X axis, that is, the second flexible part 150, with respect to the internal frame 120 but is limited from moving in the rest directions, the first and second mass bodies 110a and 110b may be displaced only with respect to force in a desired direction (the rotation based on the X axis).

Further, as illustrated in FIG. 8, a center of gravity C of the first mass body 110a is positioned on the same line, with respect to a rotating center R with which the second flexible part is coupled and the Y axis, but as illustrated in FIG. 9, a center of gravity C of the second mass body 110b is positioned to be spaced apart from the rotating center R with which the second flexible part 150 is coupled and the Y axis. That is, the second flexible part 150 is connected to the first mass body 110a so as to be opposite to the center of gravity of the first mass body 110a, such that both sides of the first mass body 110a may have the same displacement based on a rotation shaft, but the second mass body 110b is positioned so that the second flexible part 150 is spaced apart from a central portion of the second mass body 110b.

That is, the second mass body is connected to the internal frame to be eccentric by the second flexible part. Therefore, both sides of the second mass body 110b have different displacements based on the rotation shaft.

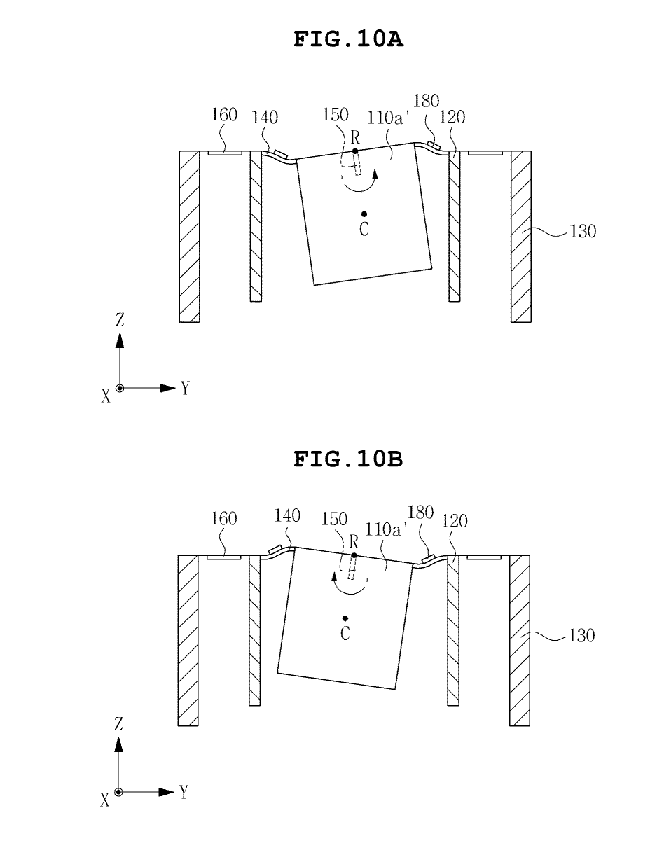

FIGS. 10A and 10B are cross-sectional views illustrating a process of allowing the first mass body illustrated in FIG. 6 to rotate based on the second flexible part with respect to the internal frame. As illustrated, as the first mass body 110a rotates based on the X axis as a rotating shaft R with respect to the internal frame 120, that is, the first mass body rotates based on an axis, with which the second flexible part is coupled, with respect to the internal frame, the first flexible part 140 has a bending stress, which is a combination of a compression stress and a tension stress, generated therein and the second flexible part 150 has a torsion stress generated therein based on the X axis.

In this case, in order to generate a torque in the first mass body 110a, the second flexible part 150 may be provided above the center of gravity C of the first mass body 110a based on the Z-axis direction.

Meanwhile, as illustrated in FIG. 2, the second flexible part 150 is disposed at a position corresponding to the center of gravity C of the first mass body 110a based on the X-axis direction so that the first mass body 110a accurately rotates based on the X axis.

Further, the bending stress of the first flexible part 140 is detected by the sensing unit 180.

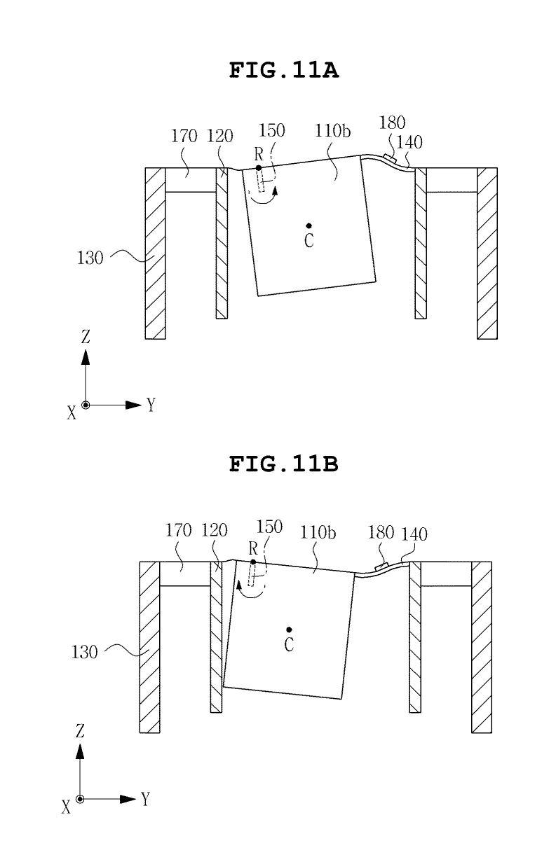

FIGS. 11A and 11B are cross-sectional views illustrating a process of allowing the second mass body illustrated in FIG. 5 to rotate based on the second flexible part with respect to the internal frame.

As illustrated, only one side of the second mass body 110b is connected to the first flexible part 140 in a Y-axis direction. Further, as the second mass body 110b rotates based on the X axis as the rotating shaft R with respect to the internal frame 120, that is, the second mass body rotates based on the shaft, with which the second flexible part is coupled, with respect to the internal frame, the first flexible part 140 has the bending stress, which is a combination of the compression stress and the tension stress, generated therein and the second flexible part 150 has the torsion stress generated therein based on the X axis.

In this case, as the rotation shaft R is spaced from one side with respect to the center of gravity C of the second mass body 110b, the second mass body 110b has different displacements with respect to one side and the other side based on the rotation shaft.

Further, the bending stress of the first flexible part 140 is detected by the sensing unit 180.

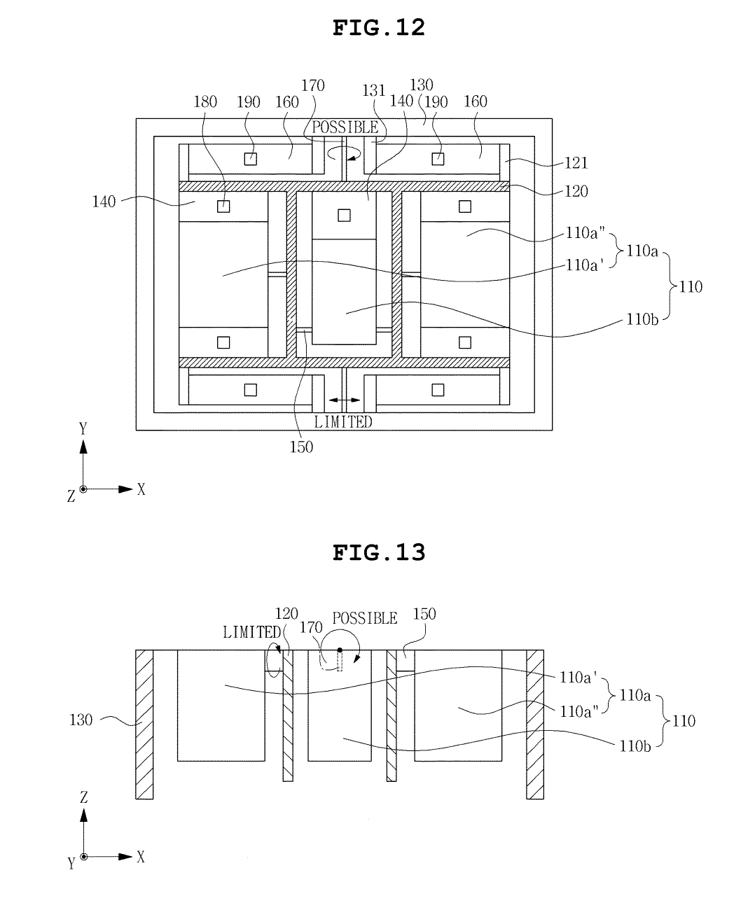

Next, the movable direction of the internal frame in the angular velocity sensor according to the first preferred embodiment of the present invention will be described in detail with reference to FIGS. 12 and 13.

FIG. 12 is a plan view illustrating a movable direction of the internal frame, in the angular velocity sensor illustrated in FIG. 2 and FIG. 13 is a cross-sectional view illustrating the movable direction of the internal frame, in the angular velocity sensor illustrated in FIG. 3.

As illustrated, since the width W₄ of the fourth flexible part 170 in the Z-axis direction is larger than the thickness T₄ thereof in the X-axis direction, the internal frame 120 is limited from rotating based on the X axis or being translated in the Y-axis direction, but may relatively freely rotate based on the Y axis, with respect to the external frame 130.

More specifically, as the rigidity of the fourth flexible part 170 at the time of rotation based on the Y axis is larger than rigidity of the fourth flexible part 170 at the time of rotation based on the X axis, the internal frame 120 may freely rotate based on the Y axis, but are limited from rotating based on the X axis. Similarly, as the rigidity of the fourth flexible part 170 at the time of the rotation based on the Y axis is larger than the rigidity thereof at the time of the translation in the Z-axis direction, the internal frame 120 may freely rotate based on the Y axis, but are limited from being translated in the Z-axis direction.

Therefore, as a value of (the rigidity of the fourth flexible part 170 at the time of the rotation based on the X axis or the rigidity of the fourth flexible part 170 at the time of the translation in the Z-axis direction)/(the rigidity of the fourth flexible part 170 at the time of the rotation based on the Y axis) of the fourth flexible part 170 increases, the internal frame 120 may freely rotate based on the Y axis, but are limited from rotating based on the X axis or being translated in the Z-axis direction, with respect to the external frame 130.

That is, as illustrated in FIGS. 2 and 4, relationships between the width W₄ of the fourth flexible part 170 in the Z-axis direction, the length L2 thereof in the Y-axis direction, and the thickness T₄ thereof in the X-axis direction and the rigidities thereof in each direction may be arranged as follows.

(1) The rigidity of the fourth flexible part 170 at the time of the rotation based on the X axis or the rigidity thereof at the time of the translation in the Z-axis direction∝T₄×W₄³/L₂³

(2) The rigidity of the fourth flexible part 170 at the time of the rotation based on the Y axis∝T₄³×W₄/L₂

According to the above two Equations, the value of (the rigidity of the fourth flexible part 170 at the time of the rotation based on the X axis or the rigidity of the fourth flexible part 170 at the time of the translation in the Z-axis direction)/(the rigidity of the fourth flexible part 170 at the time of the rotation based on the Y axis) of the fourth flexible part 170 is in proportion to (W₄/(T₄L₂))².

However, since the width W₄ of the fourth flexible part 170 in the Z-axis direction is larger than the thickness T₄ thereof in the X-axis direction, (W₄/(T₄T₂))² is large, such that the value of (the rigidity of the fourth flexible part 170 at the time of the rotation based on the X axis or the rigidity of the fourth flexible part 170 at the time of the translation in the Z-axis direction)/(the rigidity of the fourth flexible part 170 at the time of the rotation based on the Y axis) of the fourth flexible part 170 increases. Due to these characteristics of the fourth flexible part 170, the internal frame 120 rotates based on the Y axis, but is limited from rotating based on the X axis or being translated in the Z-axis direction and rotates based on only the Y axis, with respect to the external frame 130.

Meanwhile, the third flexible part 160 has relatively very high rigidity in the length direction (the X-axis direction), such that the internal frame 120 may be limited from rotating based on the Z axis or being translated in the Z-axis direction, with respect to the external frame 130. In addition, the fourth flexible part 170 has relatively very high rigidity in the length direction (the Y-axis direction), such that the internal frame 120 may be limited from being translated in the Y-axis direction, with respect to the external frame 130 (see FIG. 8).

As a result, due to the characteristics of the third and fourth flexible parts 160 and 170 described above, the internal frame 120 may rotate based on the Y axis, but is limited from rotating based on the X or Z axis or being translated in the Z, Y, or X-axis direction, with respect to the external frame 130. That is, the movable directions of the internal frame 120 may be arranged as in the following Table 2.

TABLE 2

| Moving direction of internal frame | Whether or not movement |
|---|---|
| (Based on external frame) | is possible |
| Rotation based on X axis | Limited |
| Rotation based on Y axis | Possible |
| Rotation based on Z axis | Limited |
| Translation in X-axis direction | Limited |
| Translation in Y-axis direction | Limited |
| Translation in Z-axis direction | Limited |

As described above, since the internal frame 120 may rotate based on the Y axis, but is limited from moving in the remaining directions, with respect to the external frame 130, the internal frame 120 may be displaced only with respect to force in a desired direction (the rotation based on the Y axis).

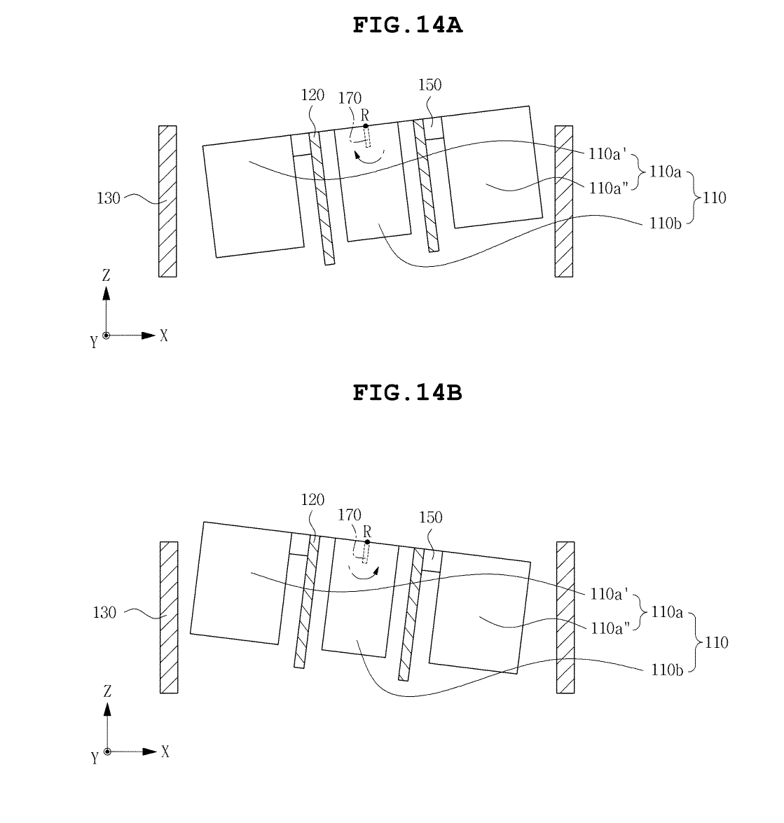

FIGS. 14A and 14B are cross-sectional views illustrating a process of allowing the internal frame illustrated in FIG. 3 to rotate based on the fourth flexible part with respect to the external frame.

As illustrated, since the internal frame 120 rotates based on the Y axis with respect to the external frame 130, that is, the internal frame 120 rotates based on the fourth flexible part 170 which is hinge-coupled with the external frame 130, the third flexible part 160 has the bending stress, which is a combination of the compression stress and the tension stress, generated therein and the fourth flexible part 170 has the torsion stress generated therein based on the Y axis.

The angular velocity sensor according to the first exemplary embodiment of the present invention is configured as described above, and a method of measuring an angular velocity using the angular velocity sensor 100 will be described in detail below.

First, the driving unit 190 rotates the internal frame 120 based on the Y axis with respect to the external frame 130. In this case, the first mass bodies 110a′ and 110a″ and the second mass body 110b are vibrated by rotating based on the Y axis along with the internal frame 120 and the first mass bodies 110a′ and 110a″ and the second mass body 110b are displaced depending on the vibration.

More specifically, displacements (+X, −Z) in the +X-axis direction and the −Z-axis direction are generated in the first one side mass body 110a′ and at the same time, displacements (+X, +Z) in the +X-axis direction and the +Z-axis direction are generated in the first other side mass body 110a″. Then, the displacements (−X, +Z) in the −X-axis direction and the +Z-axis direction are generated in the first one side mass body 110a′ and at the same time, the displacements (−X, −Z) in the −X-axis direction and the −Z-axis direction are generated in the first other side mass body 110a″. In this case, when the angular velocity rotating based on the X or Z axis is applied to the first one side mass body 110a′ and the first other side mass body 110a″, the Coriolis force is generated.

By the Coriolis force, the first one side mass body 110a′ and the first other side mass body 110a″ are displaced by rotating based on the X axis with respect to the internal frame 120 and the sensing unit 180 senses the displacements of the first one side mass body 110a′ and the first other side mass body 110a″.

In more detail, when the angular velocity rotating based on the X axis is applied to the first one side mass body 110a′ and the first other side mass body 110a″, the Coriolis force to the first one side mass body 110a′ is generated in the −Y-axis direction and then generated in the +Y-axis direction and the Coriolis force to the first other side mass body 110a′ is generated in the +Y-axis direction and then generated in the −Y-axis direction.

Therefore, the first one side mass body 110a′ and the first other side mass body 110a″ rotate in an opposite direction to each other based on the X axis and the sensing unit 180 senses each of the displacements of the first one side mass body 110a′ and the first other side mass body 110a″ to be able to calculate the Coriolis force, such that the angular velocity rotating based on the X axis may be measured by the Coriolis force.

Meanwhile, when signals each generated from the first flexible part 140 and the first sensing units 180 each connected to both ends of the first one side mass body 110a′ are defined as SY1 and SY2 and when signals each generated from the first flexible part 130 and the sensing unit 180 each connected to both ends of the first other side mass body 110a″ are defined as SY3 and SY4, the angular velocity rotating based on the X-axis direction may be calculated from (SY1−SY2)−(SY3−SY4). As described above, since the signals are differentially output between the first one side mass body 110a′ and the first other side mass bodies 110a″ rotating in the opposite direction to each other, acceleration noise may be offset.

Further, when the angular velocity rotating based on the Z axis is applied to the first one side mass body 110a′ and the first other side mass body 110a″, the Coriolis force to the first one side mass body 110a′ is generated in the −Y-axis direction and then generated in the +Y-axis direction and the Coriolis force to the first other side mass body 110a″ is generated in the −Y-axis direction and then generated in the +Y-axis direction. Therefore, the first one side mass body 110a′ and the first other side mass body 110a″ rotate in the same direction based on the X axis and the sensing unit 180 senses the displacements of the first one side mass body 110a′ and the first other side mass body 110a″ to be able to calculate the Coriolis force, such that the angular velocity rotating based on the Z axis may be measured by the Coriolis force.

In this case, when the signals each generated from the two first flexible parts 140 and the sensing unit 180 each connected to both ends of the first one side mass body 110a′ are defined as SY1 and SY2 and when the signals each generated from the first flexible part 140 and the sensing unit 180 each connected to both ends of the first other side mass body 110a″ are defined as SY3 and SY4, the angular velocity rotating based on the Z axis may be calculated from (SY1−SY2)+(SY3−SY4).

Further, an example of the calculation of the angular velocity is as follows.

As described above, when the internal frame 120 rotates based on the Y axis with respect to the external frame 130 by the driving unit 190, the first mass body 110a is vibrated by rotating based on the Y axis along with the internal frame 120 and the first mass body 110a generates velocities Vx and Vz in the X-axis and Z-axis directions depending on the vibration. In this case, when angular velocities Ωz and Ωx, which are based on the Z axis or the X axis are applied to the first mass body 110a, Coriolis force Fy is generated in the Y-axis direction.

By the Coriolis force Fy, the first mass body 110a is displaced by rotating based on the X axis with respect to the internal frame 120 and the sensing unit 180 senses the displacement of the first mass body 110a. Further, the sensing unit senses the displacement of the first mass body 110a to be able to calculate the Coriolis force Fy.

Therefore, in Fy=2mVzΩx, the angular velocity Ωx which is based on the X axis may be calculated by the Coriolis force Fy and in Fy=2mVxΩz, the angular velocity Ωh, which is based on the Z axis may be calculated by the Coriolis force Fy.

As a result, the angular velocity sensor 100 according to the first preferred embodiment of the present invention may measure the angular velocity rotating based on the X or Z axis by the first mass body 110a and the sensing unit 180.

Next, the angular velocity depending on the second mass body is detected as follows.

However, the driving unit 190 rotates the internal frame 120 based on the Y axis with respect to the external frame 130.

In this case, similar to the first mass body 110a, the second mass body 110b is vibrated by rotating based on the Y axis along with the internal frame 120 and the second mass body 110b may rotate based on the X axis with respect to the internal frame 120 due to the characteristics of the first flexible part 140 and the second flexible part 150, depending on the vibration.

That is, even though the internal frame 120 rotates based on the Y axis with respect to the external frame 130 by using the driving unit 190, the second mass body 110b does not rotate based on the Y axis with respect to the internal frame 120.

Further, due to the characteristics of the third and fourth flexible parts 160 and 170 described above, the internal frame 120 may rotate only based on the Y axis with respect to the external frame 130. Therefore, as illustrated in FIG. 13, when the displacement of the second mass body 110b is sensed using the sensing unit 180, even though the Coriolis force is applied in the Y-axis direction, the internal frame 120 does not rotate based on the X axis with respect to the external frame 130, and only the second mass body 110b rotates based on the X axis with respect to the internal frame 120.

Further, the second mass body 110b is connected to the second flexible part 150 to be eccentric with respect to the center of gravity C, only one end of the second mass body 110b is connected to the first flexible part 140 provided with the sensing unit with respect to the Y-axis direction, the other end thereof is connected to the second flexible part 150 serving as the hinge of the rotary motion with respect to the Y-axis direction, such that as described above, the second mass body 110b rotates based on the X axis with respect to the internal frame 120.

When the internal frame 120 rotates based on the Y axis with respect to the external frame 130 by the driving unit 190, the second mass body 110b is vibrated by rotating based on the Y axis along with the internal frame 120 and the second mass body 110b generates a velocity Vx in the X-axis direction depending on the vibration. In this case, when the angular velocities Ωy and Ωz which are based on the Y axis or the Z axis are applied to the second mass body 110b, the Coriolis forces Fz and Fy are generated in the Z-axis direction or the Y-axis direction and the Coriolis force generates the displacement of the second mass body 110b rotating based on the X axis with respect to the internal frame 120.

The sensing unit 180 senses the displacement of the second mass body 110b to be able to calculate the Coriolis force. By the Coriolis force, the angular velocity Ωy in the Y-axis direction+the angular velocity Ωz in the Z-axis direction is detected and by removing the angular velocity Ωz in the Z-axis direction which is measured by the central mass body 110a and the sensing unit 180, the angular velocity Ωy in the Y-axis direction may be calculated.

According to the angular velocity sensor 100 according to the first preferred embodiment of the present invention having the above configuration, the first mass body 110a may detect the angular velocity in the X-axis direction and the angular velocity in the Z-axis direction and the second mass body 110b may detect the angular velocity in the Y-axis direction, and thus is implemented as a tri-axially detecting angular velocity sensor, and the size of the mass body may be maximally secured due to the optimal structure of the internal frame and the third flexible part, thereby improving the sensitivity.

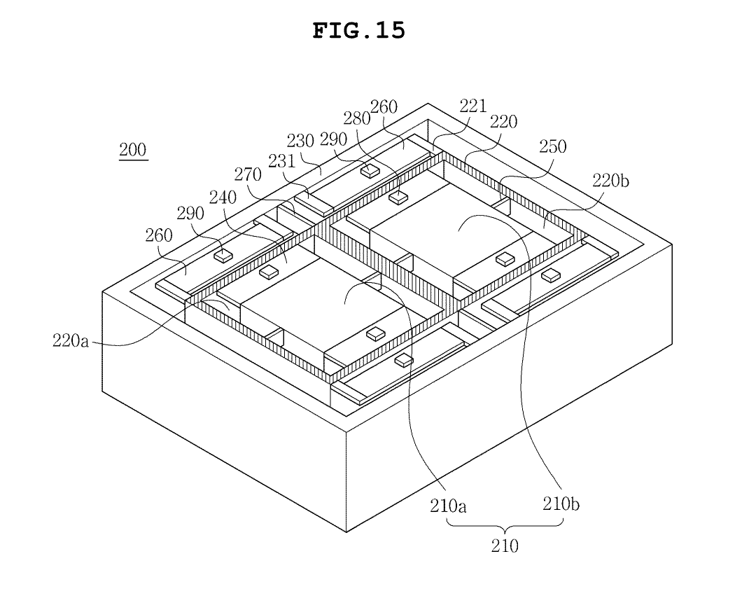

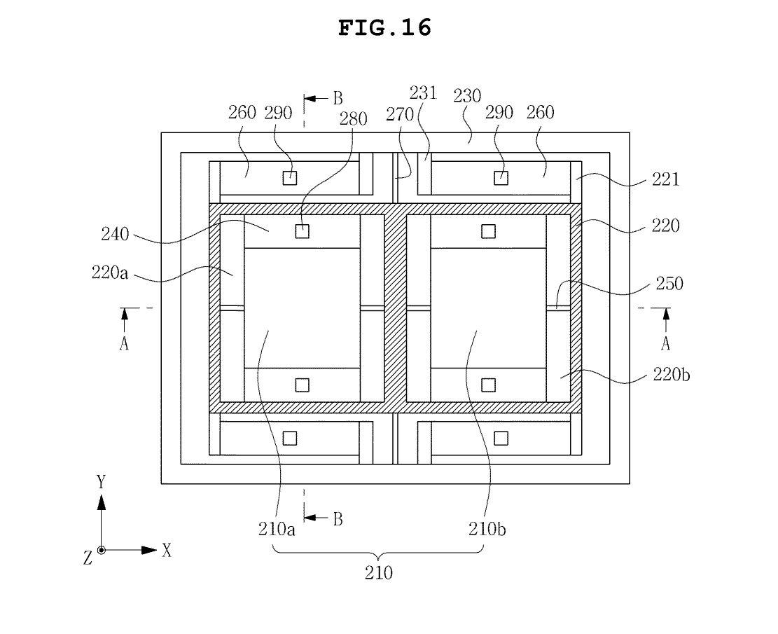

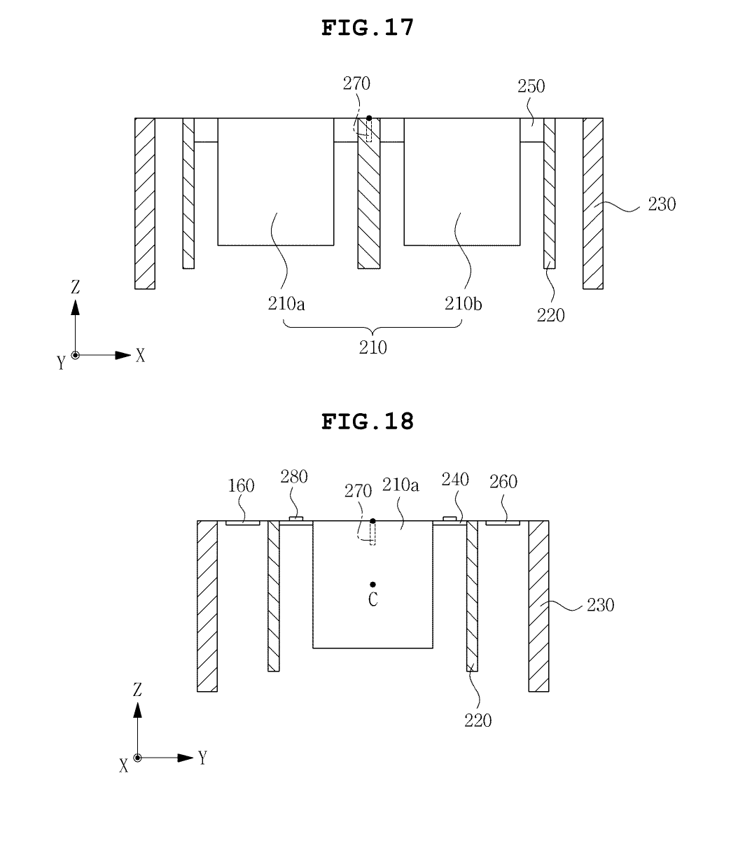

FIG. 15 is a perspective view schematically illustrating an angular velocity sensor according to a second preferred embodiment of the present invention, FIG. 16 is a schematic plan view of the angular velocity sensor illustrated in FIG. 15, FIG. 17 is a schematic cross-sectional view taken along the line A-A of the angular velocity sensor illustrated in FIG. 16, and FIG. 18 is a schematic cross-sectional view taken along the line B-B of the angular velocity sensor illustrated in FIG. 16.

As illustrated, an angular velocity sensor 200 is different from the angular velocity sensor 100 according to the first preferred embodiment of the present invention in terms of only the sensing module which is configured to include the mass body, the first flexible part, the second flexible part, and the internal frame, and is the same as the angular velocity sensor 100 in terms of the third flexible part, the fourth flexible part, the driving unit, and the external frame which support and drive the sensing module.

As illustrated, the angular velocity sensor 200 includes a mass body part 210, an internal frame 220, an external frame 230, a first flexible part 240, a second flexible part 250, a third flexible part 260, and a fourth flexible part 270.

Further, the first flexible part 240 and the second flexible part 250 are selectively provided with a sensing unit 280 as a sensing side flexible part and the third flexible part 260 and the fourth flexible part 270 are selectively provided with a driving unit 290 as a vibration side flexible part.

In more detail, the mass body part 210 is displaced by the Coriolis force and includes a first mass body 210a and a second mass body 210b and is connected to the second flexible part 250 to correspond to a center of gravity of the first mass body 210a and the second mass body 210b.

Further, the first mass body 210a and the second mass body 210b may be formed at the same size.

Further, each of the first mass body 210a and the second mass body 210b is connected to the internal frame 220 by the first flexible part 240 and the second flexible part 250.

Further, when the first mass body 210a and the second mass body 210b are applied with the Coriolis force, the first mass body 210a and the second mass body 210b are displaced based on the internal frame 220 by a bending of the first flexible part 240 and a twisting of the second flexible part 250. In this case, the first mass body 210a and the second mass body 210b rotate based on an X axis with respect to the internal frame 220 and the detailed contents thereof will be described below.

Meanwhile, the case in which the first and second mass bodies 210a and 210b have a rectangular pillar shape as a whole is illustrated, but is not limited thereto, and therefore may have all shapes known in the art.

Further, the internal frame 220 supports the mass body part 210. In more detail, the first mass body 210a and the second mass body 210b are inserted into the internal frame 220 and are connected to the mass body part 210 by the first flexible part 240 and the second flexible part 250. That is, the internal frame 220 secures a space in which the mass body part 210 may be displaced, which becomes a basis when the mass body part 210 is displaced. Further, the internal frame 220 may also be formed to cover only a part of the mass body part 210.

Further, the sensing unit 280 and the driving unit 290 are each formed on one surface of the first flexible part 240 and the third flexible part 260 as the preferred embodiment of the present invention.

Further, the internal frame 220 may be partitioned into two space parts 220a and 220b so that the first mass body 210a and the second mass body 210b may be inserted into the internal frame 220. Further, the internal frame 220 may have a rectangular pillar shape in which it has a rectangular pillar shaped cavity formed at the center thereof, but is not limited thereto.

Further, both sides of the internal frame 220 are provided with protruding coupling parts 221 so that the internal frame 220 is connected to the third flexible part 260 which is a vibration side flexible part, the external frame 230 is provided with the protruding coupling part 231 protruding toward the internal frame 220 so that the external frame 230 is connected to a third flexible part 260 which is a vibration side flexible part, one end of the third flexible part 260 is coupled with the protruding coupling part 221 of the internal frame, and the other end thereof is coupled with the protruding coupling part 231 of the external frame.

As described above, the first flexible part 240, the second flexible part 250, the third flexible part 260, and the fourth flexible part 270 of the angular velocity sensor 200 according to the second preferred embodiment of the present invention are the same as the angular velocity sensor 100 according to the first preferred embodiment of the present invention, in the shape of the first flexible part 140, the second flexible part 150, the third flexible part 160, and the fourth flexible part 170 of the angular velocity sensor 100 according to the first preferred embodiment of the present invention and the organic coupling with the mass body, and therefore the description thereof will be omitted.

However, the angular velocity sensor 200 has a structure in which in the mass body, only the first mass body 110a of the angular velocity sensor 100 according to the first preferred embodiment of the present invention is provided two, thereby detecting only a biaxial angular velocity sensor.

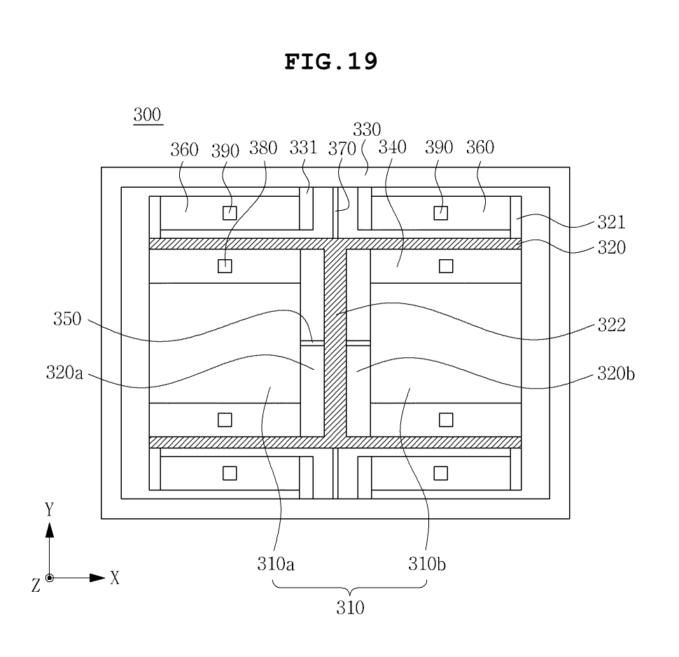

FIG. 19 is a plan view schematically illustrating an angular velocity sensor according to a third preferred embodiment of the present invention; and as illustrated, an angular velocity sensor 300 is different from the angular velocity sensor 200 according to the second preferred embodiment of the present invention in terms of the shape of the internal frame.

In more detail, the angular velocity sensor 300 includes a mass body part 310, an internal frame 320, an external frame 330, a first flexible part 340, a second flexible part 350, a third flexible part 360, and a fourth flexible part 370.

Further, the first flexible part 340 and the second flexible part 350 are selectively provided with a sensing unit 380 and the third flexible part 360 and the fourth flexible part 370 are selectively provided with a driving unit 390.

Further, the internal frame 320 is formed to be opened to both sides, which is to largely secure the mass body as much as the thickness of the frame. To this end, the middle of the internal frame 320 is connected to a connection part 322 and both sides thereof are opened to form two space parts 320a and 320b. The space parts each receive the first mass body and the second mass body.

As described above, the first flexible part 340, the second flexible part 350, the third flexible part 360, and the fourth flexible part 370 of the angular velocity sensor 300 according to the third preferred embodiment of the present invention are the same as the angular velocity sensor 200 according to the second preferred embodiment of the present invention, in the shape of the first flexible part 240, the second flexible part 250, the third flexible part 260, and the fourth flexible part 270 of the angular velocity sensor 200 according to the second preferred embodiment of the present invention and the organic coupling with the mass body, and therefore the description thereof will be omitted.

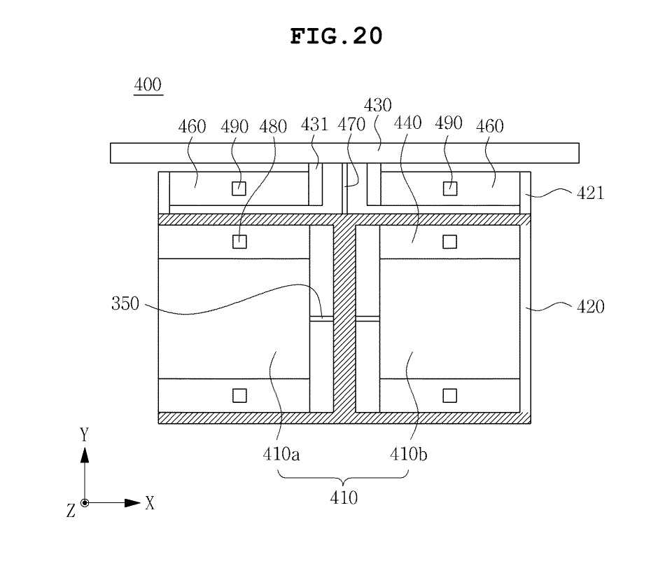

FIG. 20 is a plan view schematically illustrating an angular velocity sensor according to a fourth preferred embodiment of the present invention. As illustrated, an angular velocity sensor 400 is different from the angular velocity sensor 300 according to the third preferred embodiment of the present invention in terms of the shape of the external frame.

In more detail, the angular velocity sensor 400 includes a mass body part 410, an internal frame 420, an external frame 430, a first flexible part 440, a second flexible part 450, a third flexible part 460, and a fourth flexible part 470.

Further, the first flexible part 440 and the second flexible part 450 are selectively provided with a sensing unit 480 and the third flexible part 460 and the fourth flexible part 470 are selectively provided with a driving unit 490.

Further, one side of the external frame 430 is provided with a protruding support part 431 to support the internal frame, the protruding support part 431 is coupled with the third flexible part 460, and the external frame 430 is coupled with the fourth flexible part to support the internal frame 420.

As described above, the first flexible part 440, the second flexible part 450, the third flexible part 460, and the fourth flexible part 470 of the angular velocity sensor 400 according to the fourth preferred embodiment of the present invention is the same as the angular velocity sensor 300 according to the third preferred embodiment of the present invention, in the shape of the first flexible part 340, the second flexible part 350, the third flexible part 360, and the fourth flexible part 370 of the angular velocity sensor 300 according to the third preferred embodiment of the present invention and the organic coupling with the mass body, and therefore the description thereof will be omitted.

Although the exemplary embodiment of the present invention has been disclosed for illustrative purposes, it will be appreciated that the present invention is not limited thereto, and those skilled in the art will appreciate that various modifications, additions and substitutions are possible, without departing from the scope and spirit of the invention. Particularly, the present invention has been described based on the “X axis”, the “Y axis”, and the “Z axis”, which are defined for convenience of explanation. Therefore, the scope of the present invention is not limited thereto.

Accordingly, any and all modifications, variations or equivalent arrangements should be considered to be within the scope of the invention, and the detailed scope of the invention will be disclosed by the accompanying claims.

According to the preferred embodiments of the present invention, it is possible to provide the detection module for a sensor, which includes the second mass body eccentrically connected to the first mass body connected to correspond to the center of gravity and makes the displacement of the mass bodies different, thereby simultaneously detecting the physical quantities about the multi axes, the angular velocity sensor integrated with a driving unit, which includes the plurality of frames and forms the flexible part allowing the single driving unit to drive the frames and the mass body to individually generate the driving displacement and the sensing displacement of the mass body and forming the flexible part allowing the mass body to move only in a specific direction, thereby removing the interference between the driving mode and the sensing mode and reducing the influence due to a manufacturing error, and the angular velocity sensor which includes the plurality of frames to individually generate the driving displacement and the sensing displacement of the mass body and allowing the mass body to move only in a specific direction, thereby removing the interference between the driving mode and the sensing mode and reducing the influence due to a manufacturing error and includes the mass body which is mounted in the frame and has the second mass body connected to be eccentrically connected to the first mass body connected to correspond to the center of gravity and a second mass body connected to be spaced apart from a second mass body and makes the driving and the displacement of the first mass body and the second mass body different due to the frame driving, thereby detecting the tri-axial angular velocity, and the angular velocity sensor, which includes the vibration side flexible part disposed between the internal frame and the external frame so as to be parallel with the disposition direction of the mass body part disposed in the internal frame, thereby maximally securing the size of the mass body and improving the sensing sensitivity.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An angular velocity sensor, comprising:
a sensing module including a mass body part which includes a plurality of mass bodies disposed to be parallel with each other, an internal frame which supports the mass body, and sensing side flexible parts which rotatably connect the mass body to the internal frame;
an external frame supporting the sensing module; and
a vibration side flexible part rotatably connecting the sensing module to the external frame,
wherein the vibration side flexible part is disposed between the internal frame and the external frame to be parallel with each other with respect to a disposition direction of the mass body part which is disposed in the internal frame.

2. The angular velocity sensor as set froth in claim 1, wherein the mass body part includes:
a first mass body connected to the sensing side flexible part so as to correspond to a center of gravity; and
a second mass body connected to the internal frame so as to be eccentric by the sensing side flexible part.

3. The angular velocity sensor as set froth in claim 1, wherein the internal frame is formed to have a “ [symbol] ” shape, has both sides opened, and is provided with three space parts in the “ [symbol] ” shape and the space parts each have the mass bodies received therein.

4. The angular velocity sensor as set froth in claim 2, wherein the internal frame is provided with a protruding coupling part to which the vibration side flexible part is connected and the protruding coupling part is formed at both sides of the internal frame.

5. The angular velocity sensor as set froth in claim 4, wherein the protruding coupling part is formed at both ends of the internal frame, which extends in an X-axis direction, so as to extend in a Y-axis direction.

6. The angular velocity sensor as set froth in claim 1, wherein the external frame is provided with a protruding coupling part to which the vibration side flexible part connected to the internal frame is connected.

7. The angular velocity sensor as set froth in claim 6, wherein the protruding coupling part of the external frame protrudes toward the internal frame.

8. The angular velocity sensor as set froth in claim 1, wherein the sensing side flexible part includes a first flexible part and a second flexible part which connect each of the first mass body and the second mass body to the frame and the first flexible part and the second flexible part are disposed in an orthogonal direction to each other.

9. The angular velocity sensor as set froth in claim 8, wherein the first flexible part is a beam which has a surface formed by one axis direction and the other axis direction and a thickness extending in an orthogonal direction of the surface.

10. The angular velocity sensor as set froth in claim 9, wherein the first flexible part is a beam which has a predetermined thickness in a Z-axis direction and has a surface formed by an X axis and a Y axis and a width W₁ in an X-axis direction is formed to be larger than a thickness T₁ in a Z-axis direction.

11. The angular velocity sensor as set froth in claim 8, wherein the second flexible part is a hinge which has a thickness in one axis direction and has a surface formed in the other axis direction.

12. The angular velocity sensor as set froth in claim 9, wherein the second flexible part is a hinge which has a predetermined thickness in a Y-axis direction and has a surface formed by an X axis and a Z axis and a width W₂ in a Z-axis direction is formed to be larger than a thickness T₂ in a Y-axis direction.

13. The angular velocity sensor as set froth in claim 8, wherein one surface of the first flexible part or the second flexible part is selectively provided with a sensing unit which senses a displacement of the mass body.

14. The angular velocity sensor as set froth in claim 1, wherein the vibration side flexible part includes a third flexible part and a fourth flexible part which connect the internal frame to the external frame and the third flexible part and the fourth flexible part are disposed in an orthogonal direction to each other.

15. The angular velocity sensor as set froth in claim 14, wherein the third flexible part is a beam which has a surface formed by one axis direction and the other axis direction and a thickness extending in an orthogonal direction of the surface.

16. The angular velocity sensor as set froth in claim 15, wherein the third flexible part is a beam which has a predetermined thickness in a Z-axis direction and has a surface formed by an X axis and a Y axis and a width W₃ in a Y-axis direction is formed to be larger than a thickness T₃ in a Z-axis direction.

17. The angular velocity sensor as set froth in claim 14, wherein the fourth flexible part is a hinge which has a thickness in one axis direction and has a surface formed in the other axis direction.

18. The angular velocity sensor as set froth in claim 17, wherein the fourth flexible part is a hinge which has a predetermined thickness in a X-axis direction and has a surface formed by an Y axis and a Z axis and a width W₄ in a Z-axis direction is formed to be larger than a thickness T₄ in an X-axis direction.

19. The angular velocity sensor as set froth in claim 14, wherein one surface of the third flexible part or the fourth flexible part is selectively provided with a driving unit which drives the internal frame.

20. The angular velocity sensor as set froth in claim 19, wherein when the internal frame is driven by the driving unit of the third flexible part, the internal frame rotates based on an axis with which the fourth flexible part is coupled, with respect to the external frame.

21. The angular velocity sensor as set froth in claim 20, wherein when the internal frame rotates based on an axis with which the fourth flexible part is coupled, a bending stress is generated in the third flexible part and a twisting stress is generated in the fourth flexible part.

22. The angular velocity sensor as set froth in claim 20, wherein when the internal frame rotates based on an axis with which the fourth flexible part is coupled, the first mass body and the second mass body rotate based on the shaft with which the second flexible part is coupled, with respect to the internal frame.

23. The angular velocity sensor as set froth in claim 22, wherein when the first mass body and the second mass body rotate, the bending stress is generated in the first flexible part and the twisting stress is generated in the second flexible part.

24. The angular velocity sensor as set froth in claim 2, wherein both ends of the first mass body are connected to the first flexible part with respect to the Y-axis direction, and one end of the second mass body is connected to the first flexible part with respect to the Y-axis direction.

25. The angular velocity sensor as set froth in claim 2, wherein the first mass body includes:
a first one side mass body positioned at one side of the second mass body based on the second mass body; and
a first other side mass body positioned at the other side of the second mass body based on the second mass body.

26. The angular velocity sensor as set froth in claim 25, wherein one end of the first one side mass body and one end of the first other side mass body are connected to the second flexible part with respect to an X-axis direction.

27. The angular velocity sensor as set froth in claim 14, wherein the external frame is provided with a protruding coupling part to which the third flexible part is connected and the protruding coupling part protrudes toward the internal frame.

28. An angular velocity sensor, comprising:
a sensing module including a mass body part which includes a plurality of mass bodies disposed to be parallel with each other, an internal frame which movably supports the mass body, and sensing side flexible parts which rotatably connect the mass body to the internal frame;
an external frame supporting the sensing module; and
a vibration side flexible part rotatably connecting the sensing module to the external frame,
wherein the vibration side flexible part is disposed between the internal frame and the external frame so as to be parallel with the mass body part, and
the sensing side flexible part is connected to a first mass body and a second mass body, respectively, so as to correspond to a center of gravity.

29. The angular velocity sensor as set froth in claim 28, wherein the internal frame has a rectangular pillar shape partitioned into two space parts so as to have the first mass body and the second mass body thereinto.

30. The angular velocity sensor as set froth in claim 28, wherein both sides of the internal frame are provided with a protruding coupling part so as to be connected to the vibration side flexible part, the external frame is provided with the protruding coupling part protruding toward the internal frame so as to be connected to the vibration side flexible part, one end of the vibration side flexible part is coupled with the protruding coupling part of the internal frame, and the other end thereof is coupled with the protruding coupling part of the external frame.

31. The angular velocity sensor as set froth in claim 28, wherein the sensing side flexible part includes a first flexible part and a second flexible part which connect each of the first mass body and the second mass body to the frame and the first flexible part and the second flexible part are disposed in an orthogonal direction to each other.

32. The angular velocity sensor as set froth in claim 28, wherein the vibration side flexible part includes a third flexible part and a fourth flexible part which connect the internal frame to the external frame and the third flexible part and the fourth flexible part are disposed in an orthogonal direction to each other.

33. The angular velocity sensor as set froth in claim 28, wherein a middle of the internal frame is provided with a connection part and both sides thereof are opened to form two space parts, and the space part has each of the first mass body and the second mass body received therein.

34. The angular velocity sensor as set froth in claim 28, wherein one side of the external frame is provided with a protruding support part to support the internal frame and the protruding support part is coupled with the vibration side flexible part.
